(19) United States
(12) Patent Application Publication
(10) Pub. No.: US 2023/0384554 A1
(43) Pub. Date: Nov. 30, 2023

(54) COMPONENT, APPARATUS, AND OPTICAL APPARATUS

(71) Applicant: CANON KABUSHIKI KAISHA, Tokyo (JP)

(72) Inventors: MIWA TAKACHI, Kanagawa (JP); REIKO KUBOTA, Kanagawa (JP)

(21) Appl. No.: 18/305,459

(22) Filed: Apr. 24, 2023

(30) Foreign Application Priority Data
May 24, 2022 (JP) 2022-084487

(51) Int. Cl. G02B 7/02; G02B 7/14; D04C 1/02; D04C 1/06; D06N 3/00; D06N 3/04; D06N 3/14; D06N 3/18

(52) U.S. Cl. CPC G02B 7/028; G02B 7/14; D04C 1/02; D04C 1/06; D06N 3/0002; D06N 3/0056; D06N 3/0063; D06N 3/042; D06N 3/14; D06N 3/183; D06N 2201/087

(57) ABSTRACT

A component includes a base portion made of fiber-reinforced resin, a first layer formed on the base portion, and a second layer formed on the first layer. A Vickers hardness of the second layer is higher than a Vickers hardness of the first layer. The Vickers hardness of the first layer is in a range equal to or larger than 50 HV and equal to or smaller than 250 HV.

### BACKGROUND OF THE INVENTION

### Field of the Invention

The present invention relates to a component on which outer surface a film is formed, an apparatus and an optical apparatus which include the component, and the like.

### Description of the Related Art

Optical apparatuses, such as a camera, a video camera, a telescope, and binoculars, are irradiated with the sunlight or the like. Thus, depending on a use state, the temperature of the exterior of each of the optical apparatuses may rise. In addition, a monitoring camera, which is installed in an environment (e.g., a high-temperature plant such as an iron works) that radiates intense infrared light, and a surveillance camera and a weather camera, which are installed fixedly in the outdoors, are also irradiated with the infrared light or the sunlight; and the temperature of the exterior of each of the cameras may rise. If the temperature of the exterior of an optical apparatus rises excessively due to the light irradiation, a user may have difficulty in handling or operating the optical apparatus, and the optical apparatus may not normally operate because the internal mechanism is heated.

For reducing the temperature rise, Japanese Patent Application Publication No. 2010-282190 proposes an optical apparatus in which a reflecting surface is formed on a surface of a cylindrical portion. The reflectivity of the reflecting surface is equal to or larger than 50% in a range of wavelength of light equal to or larger than 1000 nm and smaller than 1700 nm.

By the way, the optical apparatuses, such as a camera, a video, a telescope, and binoculars, are required to have an exterior component having not only light weight, but also high strength and excellent shock resistance.

Japanese Patent Application Publication No. 2019-194018 describes manufacturing of a component, such as a lens-barrel component, that has not only light weight but also high strength. Specifically, the component is manufactured by using a composite material in which a plurality of carbon fibers, which are braided so as to cross each other, is bonded to each other via resin.

In the composite material described in Japanese Patent Application Publication No. 2019-194018 and other known carbon-fiber reinforced plastics, fibers arranged in different directions are bonded to each other via resin. Such a composite material has not only light weight, but also high strength and excellent shock resistance. However, the composite material, in which the fibers are arranged in different directions, thermally expands or contracts in the axial directions of the fibers when the environmental temperature changes.

In a case where the composite material, which has light weight and high strength, is used in an exterior component of an optical apparatus, a reflecting film can be formed on the surface of the exterior component for reducing the temperature rise caused by the irradiation of external light. In the composite material, however, when the environmental temperature changes, the fibers expand or contrast, as described above, in the directions in which the fibers are arranged. Thus, the shape of the base material of the reflecting film locally changes unevenly. If the change in the environmental temperature is repeated, or the amplitude of the change in the environmental temperature is large, stress will be applied, in various direction, onto the reflecting film formed on the surface of the composite material. As a result, a crack may be formed in the reflecting film, causing the reflecting film to crack; or the reflecting film may peel off from the composite material.

In another case, not the reflecting film but another film (e.g., a coating film) may be formed on a surface of a component for giving the component a well-designed external appearance. If the base material of the component is the composite material, in which fibers arranged in different directions, are bonded to each other via resin, such a film will also easily crack or peel off from the base material when the environmental temperature changes.

For these reasons, it has been desired to achieve a technique for forming a film that hardly cracks or peel off even when the environmental temperature changes, on a surface of a composite material in which fibers arranged in different directions are bonded to each other via resin.

### SUMMARY OF THE INVENTION

According to a first aspect of the present invention, a component includes a base portion made of fiber-reinforced resin, a first layer formed on the base portion, and a second layer formed on the first layer. A Vickers hardness of the second layer is higher than a Vickers hardness of the first layer. The Vickers hardness of the first layer is in a range equal to or larger than 50 HV and equal to or smaller than 250 HV.

Further features of the present invention will become apparent from the following description of exemplary embodiments with reference to the attached drawings.

### BRIEF DESCRIPTION OF THE DRAWINGS

FIG. 1 is a partial cross-sectional view in which a cross section of one portion of a cylindrical component 100 of an embodiment is schematically illustrated.

FIG. 2A is a plan view illustrating an outer shape of a cylindrical base material 20.

FIG. 2B is a cross-sectional view taken along a plane in which a central axis of the cylinder extends.

FIG. 3 is an external view of a braiding apparatus 6 used for braiding a fiber material, like a braid.

FIG. 4 is an external view of an interchangeable lens for cameras, illustrated as an apparatus of an embodiment.

### DESCRIPTION OF THE EMBODIMENTS

Next, a component of an embodiment of the present invention will be described with reference to the accompanying drawings. Note that since the embodiments described below are examples, a detailed configuration and the like may be modified as appropriate by a person skilled in the art, without departing the spirit of the present invention.

Note that in the drawings referred to in the following embodiments and examples, an element given an identical reference numeral has an identical function, unless otherwise specified.

In addition, the drawings may illustrate components schematically for convenience of description and illustration. Thus, the shape, size, arrangement, and the like of components illustrated in a figure may not strictly be equal to those of corresponding real components. In addition, if a plurality of identical components is illustrated in a figure, a symbol given to the component and the description thereof may be omitted.

### Embodiment

A component that will be described in the present embodiment is, for example, a cylindrical component that is used in an optical apparatus, such as an interchangeable lens for cameras. That is, the component is a cylinder-shaped component that constitutes a lens hood, a focus ring, a frame of a lens barrel, or the like. The lens hood is a light blocking component that blocks undesired light so that the undesired light, other than the light for taking a picture, does not enter the optical system for taking a picture. The lens hood is detachably attached to, for example, an end portion of an optical apparatus (image pickup apparatus), such as a camera. The lens-barrel components, such as an outer barrel, an inner barrel, and a focus ring, constitute a frame of a lens barrel, which holds or adjusts optical elements such as a lens and a mirror.

Note that the shape of the component of an embodiment of the present invention is not necessarily limited to a cylindrical shape. The present disclosure can be applied to components, such as plate-shaped components and bar-shaped components, that have various shapes as long as the components are required to have light weight and predetermined strength and reduce the temperature rise caused by the irradiation of external light, or as long as the components are given well-designed aesthetic appearance. In addition, the components for which the present invention can be embodied are not limited to components used in optical apparatuses. For example, the present invention can be applied to exterior components used in portable computers, portable communication devices, movable devices such as drones, and the like.

As described below, a laminated film is formed on a surface of a component of an embodiment. For example, the laminated film has a function that allows the laminated film to serve as a reflecting film, or a function that gives the component a well-designed external appearance (e.g., color or texture such as grain).

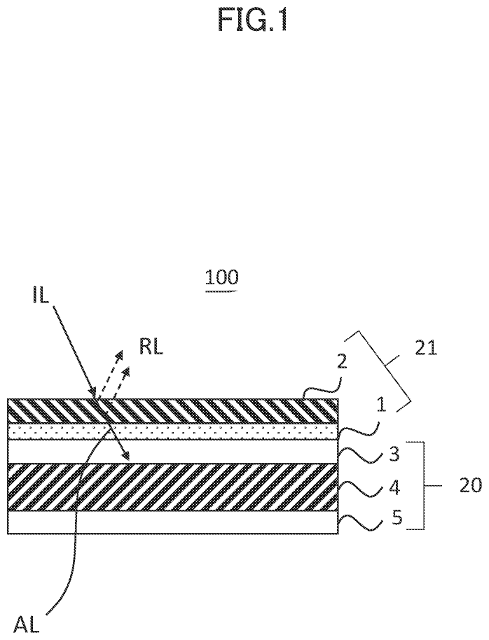

FIG. 1 is a partial cross-sectional view in which a cross section of one portion of a cylindrical component 100 of the present embodiment is schematically illustrated. The component 100 includes a base material 20, and a laminated film 21 formed on an outer surface of the base material 20. The laminated film 21 includes a first layer 1 and a second layer 2. For example, the second layer 2 is a layer that reflects part of incident light IL (e.g., infrared light) and reduces absorbed light AL. Specifically, the component 100 is irradiated with the incident light IL, and part of the incident light IL is reflected, as reflected light RL. The absorbed light AL is absorbed by the base material 20, causing the temperature rise. Thus, the second layer 2 may be referred to as a reflecting layer. The first layer 1 is a layer that connects the second layer 2 and the base material 20. The first layer 1 may be referred to as a base-material layer for the second layer 2. Hereinafter, each part will be described in detail.

### Base Material

The base material (i.e., base portion) of the component of the present embodiment is made of a composite material in which fibers arranged in different directions are bonded to each other via resin, like a carbon-fiber reinforced plastic. The base material 20 described below is one example of the base material. However, the base material is not limited to this example. That is, another base material may be used as the base material of the component of the present invention, as long as the other base material includes a composite material in which fibers arranged in different directions are bonded to each other via resin. Note that in the following description, the cross-sectional shape of a fiber or a fiber material is not limited to a specific shape, unless otherwise specified. For example, the fiber or the fiber material may be a thread or a string whose cross-sectional shape is a substantially circular shape, or may be a so-called tape whose cross-sectional shape is a rectangular shape with an aspect ratio that is not one. In another case, the fiber or the fiber material may be a string whose cross-sectional shape is another shape.

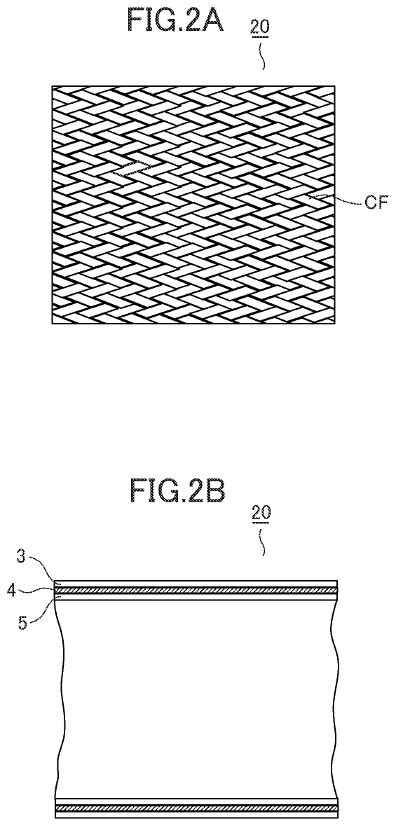

FIG. 2A is a plan view illustrating an outer shape of the cylindrical base material 20. FIG. 2B is a cross-sectional view of the base material 20, taken along a plane in which the central axis of the cylinder extends. The base material 20 is a cylindrical fiber-reinforced resin body in which a braid layer a prepreg sheet layer 4, and a braid layer 3 are laminated on each other. Each of the braid layers 5 and 3 is a layer in which carbon fibers CF are braided like a braid. The fiber used in the fiber-reinforced resin body is preferably a carbon fiber having light weight and high strength, but may be another fiber.

In the base material 20 used in the present embodiment, each of the carbon fibers CF, braided like a braid and arranged in different directions, expands or contracts in a corresponding axial direction when the temperature changes. Since the direction of the fiber differs depending on a position (area) in the base material 20, the anisotropy in coefficient of linear expansion is produced depending on a position in the base material. In other words, if the coefficient of linear expansion is measured at each position in the base material, the coefficient of linear expansion differs depending on the direction of measurement. The maximum value in the difference of the coefficient of linear expansion, which is produced in the base material 20 depending on the direction of measurement, is in a range equal to or larger than 100×10⁻⁶/° C. and equal to or smaller than 130×10⁻⁶/° C.

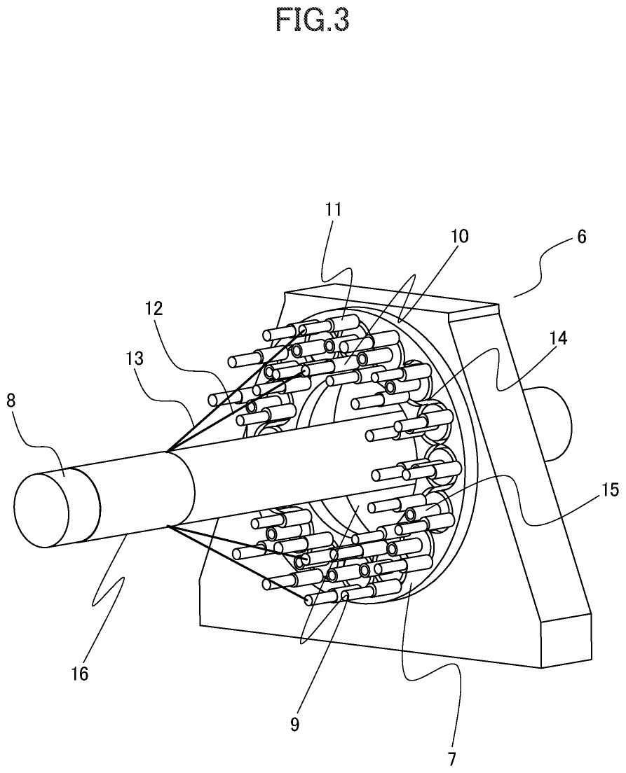

Next, a method of manufacturing the base material 20 will be described. FIG. 3 illustrates a braiding apparatus 6 used for braiding a fiber material, like a braid. The braiding apparatus 6 includes an annular frame 7, which includes a through-hole portion 9. A cylinder-shaped mandrel 8 has a diameter that is substantially constant, and is positioned by a unit (not illustrated) in a state where the mandrel 8 is inserted in the through-hole portion 9 of the annular frame 7 and positioned in the vicinity of the axis of the through-hole portion 9. The annular frame 7 includes carriers 10 and 11, around which threads 12 and 13 for forming a braid layer are wound. Preferably, the threads 12 and 13 are carbon fibers.

The carriers 10 and 11 are moved around the mandrel 8, by a driving unit (not illustrated), on the annular frame 7 in respective directions opposite to each other. Specifically, each of the carriers 10 and 11 moves around the mandrel 8 while moving along a figure-8-shaped trajectory 14 formed around a pipe body 15. With this operation, a cylindrical braid layer is formed by braiding the threads 12 and 13 in a method, such as the braiding method. FIG. 3 simply illustrates a braid layer 16 in which fibers are braided like a cylinder.

In each of the carriers 10 and 11, a bobbin (details of which are not illustrated) is mounted; and each of the threads 12 and 13 is wound around a corresponding bobbin. In addition, each of the carriers 10 and 11 includes a mechanism (details of which are not illustrated) that produces tension for winding a corresponding one of the threads 12 and 13 around the mandrel 8. For example, the tension is produced by using spring force. The direction in which the carrier 10 moves is opposite to the direction in which the carrier 11 moves. That is, the carriers 10 and 11 move in directions different from each other, each moving along the figure-8-shaped trajectory 14 formed on the annular frame 7. The braid layer is formed on the mandrel 8 by the movement of the carriers 10 and 11.

The fibers braided like a cylinder by using the above-described braiding apparatus 6, and a cylindrical body that contains thermoplastic resin are set on the mandrel 8 of the braiding apparatus 6. Preferably, carbon fiber is used as the fiber, and polycarbonate or nylon is used as the thermoplastic resin.

As illustrated in FIG. 2B, the cylindrical base material 20 has the laminated structure in which the braid layer 3 made of carbon fiber, the prepreg sheet layer 4 impregnated with the thermoplastic resin in advance, and the braid layer 5 made of carbon fiber are laminated on each other. That is, the base material 20 is a material in which the carbon fibers are braided by using the braiding apparatus 6 illustrated in FIG. 3, such that the prepreg sheet layer 4 impregnated with the thermoplastic resin in advance is sandwiched between the braid layer 3 made of carbon fiber and the braid layer 5 made of carbon fiber. Note that for setting the cylindrical body that includes the fibers having been braided and the cylindrical body that contains the thermoplastic resin, on the mandrel 8, the prepreg sheet as illustrated in FIG. 2B may not be used. For example, the braid layer may be formed by braiding carbon fibers coated with the thermoplastic resin.

The cylindrical bodies that are set on the mandrel 8 and the mandrel 8 are heated by a heating unit disposed inside the mandrel 8 and a heating unit disposed outside the mandrel 8. Each of the heating units may be an infrared heater, such as a halogen heater. If the mandrel 8 or the cylindrical bodies are electrically conductive, a coil may be disposed, and the mandrel 8 or the cylindrical bodies may be heated through induction heating. In another case, a cartridge heater may be disposed on the mandrel 8, and the cylindrical bodies may be heated by the heat transmitted from the mandrel 8. The resin for bonding the carbon fiber sheet may be a thermosetting resin, such as phenol resin or epoxy resin; or may be a thermoplastic resin, such as polycarbonate. More Preferably, the resin for bonding the carbon fiber sheet is polycarbonate because the uncured monomer less volatilizes and the polycarbonate causes excellent shock resistance.

The heated cylindrical bodies are cooled and the resin solidifies, so that the base material 20 made of the carbon-fiber reinforced plastic is completed.

The base material 20 has a predetermined thickness. Preferably, the thickness of the base material 20 is in a range equal to or larger than 0.5 mm and equal to or smaller than 5 mm. More preferably, the thickness of the base material 20 is in a range equal to or larger than 0.5 mm and equal to or smaller than 2 mm. This is because if the thickness is smaller than 0.5 mm, it becomes difficult to keep the shape of the lens barrel, and if the thickness is larger than 5 mm, the weight of the component increases, making it difficult for a user to handle the lens barrel.

### First Layer

In the present embodiment, the first layer 1, which serves as a base-material layer, has a specific Vickers hardness, as described below. This is for suppressing the cracking and peeling of the laminated film 21 even if the fibers contained in the base material 20 and arranged in different directions thermally expand and contract in the different directions, along the axial directions of the fibers.

Specifically, the Vickers hardness of the first layer 1 of the present embodiment is in a range equal to or larger than 50 HV and equal to or smaller than 250 HV More preferably, the Vickers hardness of the first layer 1 of the present embodiment is in a range equal to or larger than 70 HV and equal to or smaller than 200 HV Note that in the following description, the Vickers hardness is a value measured under a condition in which a test force of 0.4903 N is applied onto a sample in a room temperature, unless otherwise specified. If the Vickers hardness of the first layer 1 is smaller than 50 HV, the first layer 1 is too soft for the base material. Thus, in this case, when the component 100 contacts or slides on another component, the shape of the surface of the second layer 2 may deform, or the laminated film 21 may easily wear or peel off. If the Vickers hardness is larger than 250 HV, the effect that suppresses the cracking of the laminated film 21 becomes insufficient (the cracking is caused by the anisotropic expansion and contraction of the base material 20 caused by the change in environmental temperature). Thus, in the present embodiment, the first layer 1 is formed such that the Vickers hardness is in a range equal to or larger than 50 HV and equal to or smaller than 250 HV Note that the first layer 1 can have a function that increases the adhesion between the base material 20 and the laminated film 21. The component to which the present invention is applied can be fixed to a housing of each of various apparatuses, for example, by using a fixing member, such as adhesive or screws, or by causing a projecting portion and a recessed portion to engage the component with the housing.

The material of the first layer 1 may contain one or more of resin materials, such as epoxy resin, urethane resin, acrylic resin, silicone resin, and fluororesin.

For giving the first layer 1 the flexibility for a low-temperature environment (for example, an environment in which the temperature is below the freezing point), it is preferable that the first layer 1 contain plasticizer whose pour point is equal to or lower than −30° C. and whose boiling point is equal to or higher than 350° C. More preferably, the first layer 1 contains plasticizer whose pour point is equal to or lower than −40° C. and whose boiling point is equal to or higher than 400° C. This is because if the plasticizer whose pour point is higher than −30° C. is contained in the first layer 1, the first layer 1 becomes too hard in the low-temperature environment. In this case, the first layer 1 cannot absorb the uneven stress applied from the base material 20 in which respective portions contract in different directions, so that the second layer 2 may crack. In contrast, if the plasticizer whose boiling point is lower than 350° C. is contained in the first layer 1, the plasticizer may volatilize in a heating process for forming the laminated film 21, or when the component (apparatus) is placed in a high-temperature environment. In this case, the flexibility of the first layer 1 may not be kept. Thus, since the plasticizer having the above-described physical properties is contained in the first layer 1, the flexibility of the first layer 1 can be ensured, especially in a low-temperature environment (for example, an environment in which the temperature is below the freezing point). As a result, the first layer 1 can suppress the cracking of the second layer 2 by absorbing the strain caused by the stress applied between the base material 20 and the second layer 2. Note that the pour point of the plasticizer can be determined by performing the quantitative analysis on the material of the first layer 1 by using a gas chromatograph mass spectrometer (GC/MS).

The content of the plasticizer contained in the first layer 1 is preferably in a range equal to or larger than 1 wt % and equal to or smaller than 20 wt %, and more preferably, in a range equal to or larger than 1 wt % and equal to or smaller than 16 wt %. This is because if the content is smaller than 1 wt %, the flexibility of the first layer 1 may be insufficient, and if the content is larger than 20 wt %, the first layer 1 becomes too soft, causing the surface of the coating film of the second layer to be easily scratched, and causing the second layer to easily peel off.

The plasticizer may be at least one selected from the group of phthalate diesters, dialkylbenzenes, and sebacate diesters. The phthalate diesters are especially preferable because they are thermally stable and have excellent weather resistance.

The thickness of the first layer 1 is preferably in a range equal to or larger than 2 μm and equal to or smaller than 50 μm, and more preferably, in a range equal to or larger than 5 μm and equal to or smaller than 30 μm. This is because if the thickness is smaller than 2 μm, the adhesion between the base material 20 and the laminated film 21 may deteriorate, and if the thickness is larger than 50 μm, the shape accuracy of the component may deteriorate.

### Second Layer

In the present embodiment, it is preferable that the second layer 2, which serves as a reflecting layer, contain inorganic particles and/or resin and/or pigment.

Preferably, the inorganic particles contained in the second layer 2 are made of rutile-type titanium oxide, anatase-type titanium oxide, zinc oxide, silica, zirconium oxide, aluminum oxide, aluminum, or the like. For giving the heat blocking performance (the performance for reflecting the infrared light and the like) to the second layer for the irradiation of the sunlight or the like, it is especially preferable that the inorganic particles be made of rutile-type titanium oxide, anatase-type titanium oxide, zirconium oxide, zinc oxide, or the like.

For suppressing the reaction between the inorganic particles and the resin, which are contained in the second layer 2, inactivation treatment may be performed on the surface of the inorganic particles. For example, the surface of the titanium-oxide particles may be coated with one or more layers of silica, zirconium oxide, aluminum oxide, organic substance, or the like.

Preferably, the content of the inorganic particles contained in the second layer 2 is equal to or larger than 20 mass % and equal to or smaller than 70 mass %. If the content of the inorganic particles is smaller than 20 mass %, the heat blocking performance (the performance for reflecting the infrared light and the like) of the second layer 2 may become insufficient, and the second layer 2 may become insufficient in hardness, and may be easily scratched. In contrast, if the content of the inorganic particles is larger than 70 mass %, the brittleness of the second layer 2 may increase.

Preferably, the average particle diameter of the inorganic particles contained in the second layer 2 is equal to or larger than 0.2 μm and equal to or smaller than 5.0 μm. If the average particle diameter is smaller than 0.2 μm, the particles may aggregate, causing the film to be brittle. In contrast, if the average particle diameter is larger than 5.0 μm, projections and depressions of the surface of the layer increase, so that the specifications in shape accuracy required for the component 100 (e.g., shape accuracy required for the exterior of an optical apparatus) may not be satisfied. That is, if the projections and depressions of the surface of the layer increase excessively, assembly accuracy may deteriorate, which causes the deviation of the optical axis and the deterioration of the accuracy of focusing. The assembly accuracy is accuracy required for completing an optical apparatus by combining components with each other.

If the inorganic particles are titanium-oxide particles, the average particle diameter is preferably in a range equal to or larger than 10 nm and equal to or smaller than 5.0 μm, and more preferably, in a range equal to or larger than 100 nm and equal to or smaller than 3.0 μm. This is because if the inorganic particles are titanium-oxide particles having an average particle diameter smaller than 10 nm, the surface area of the particles increases, which may cause active photocatalysis and easily change the color of the resin. As already described above, if the average particle diameter is larger than 5.0 μm, projections and depressions of the surface of the layer increase, so that the specifications in shape accuracy required for the component 100 may not be satisfied.

Note that the average particle diameter of the particles contained in the layer can be determined by using the below-described method. First, a sample of the layer is extracted, and the target particles are identified by performing the qualitative analysis by using the energy dispersive X-ray spectroscopy (EDS). Then, the average particle diameter of the target particles is determined by performing a binarization process or the like on an image captured by a transmission electron microscope, by using an image processing software, such as an ImageJ (ver 1.51) made by National Institute of Health (NIH).

The resin contained in the second layer may be any resin as long as the resin can ensure the adhesion. One example of the resin is epoxy resin, urethane resin, acrylic resin, acrylic urethane resin, fluororesin, silicone resin, phenol resin, or alkyd resin. The resin may be one or more of the above-described types of resin.

Preferably, the content of the resin contained in the second layer 2 is in a range equal to or larger than 10 mass % and equal to or smaller than 80 mass %. This is because if the content of the resin is smaller than 10 mass %, the adhesion between the second layer 2 and the base material 20 may deteriorate, and if the content of the resin is larger than 80 mass %, the heat blocking performance (the performance for reflecting the infrared light and the like) for the irradiation of the sunlight or the like may become insufficient.

Preferably, the pigment contained in the second layer 2 is a coloring agent, which adjusts the color of the second layer 2 so that the brightness of the second layer 2 is equal to or higher than 50. The brightness is more preferably in a range equal to or higher than 55 and equal to or lower than 85. If the brightness is lower than 50, the heat blocking performance (the performance for reflecting the infrared light and the like) for the irradiation of the sunlight or the like may become insufficient. In contrast, if the brightness is higher than 85, the intensity of light reflected from the surface of the component 100 increases, so that the intensity of visible light that enters the eyes of a user increases, adversely affecting the handling of the component 100. Preferably, the pigment is a material that reflects or transmits the infrared light.

The pigment contained in the second layer 2 may be an organic pigment, an inorganic pigment, or a combination thereof. Examples of the organic pigment include azomethine black, perylene pigment, and quinacridone-series pigment. Examples of the inorganic pigment include Co—Zn—Si based pigment, Co—Al based pigment, Co—Al—Cr based pigment, Co—Al—Cr—Zn based pigment, Co—Al—Zn—Ti based pigment, Co—Ni—Zn—Ti based pigment, Ti—Cr—Sb based pigment, Ti—Fe—Zn based pigment, Fe—Zn based pigment, Fe—Cr based pigment, Mn—Bi based pigment, Co—Cr—Zn—Sb based pigment, Cu—Cr based pigment, Cu—Cr—Mn based pigment, Cu—Fe—Mn based pigment, Mn—Y based pigment, Mn—Sr based pigment, Co—Cr—Zn—Al—Ti based pigment, Co—Cr—Zn—Ti based pigment, Ti—Cr—Sb based pigment, and P—Ba—Sr based pigment.

The pigment contained in the second layer 2 may be a pigment with any color. For example, the pigment may have a color of black, brown, yellow, red, blue, violet, pink, green, orange, or the like. The second layer 2 may contain one type of the pigments, or may contain a plurality of types of the pigments.

The average particle diameter of the pigment contained in the second layer 2 is preferably in a range equal to or larger than 10 nm and equal to or smaller than 5000 nm, and more preferably, in a range equal to or larger than 100 nm and equal to or smaller than 3000 nm. This is because if the average particle diameter of the pigment is smaller than 10 nm, the weather resistance may deteriorate. In contrast, if the average particle diameter is larger than 5000 nm, projections and depressions of the surface of the second layer 2 increase, so that the specifications in shape accuracy required for the component 100 (e.g., shape accuracy required for a component of an optical apparatus) may not be satisfied. That is, if the projections and depressions of the surface increase, assembly accuracy may deteriorate, which causes the deviation of the optical axis and the deterioration of the accuracy of focusing. The assembly accuracy is accuracy required for completing an optical apparatus by combining components with each other.

Preferably, the content of the pigment contained in the second layer 2 is equal to or smaller than 5 wt %. This is because if the content of the pigment is larger than 5 wt %, the color of the laminated film 21 darkens and the brightness decreases rapidly. There is not a specific lower limit of the content of the pigment. Thus, the lower limit of the pigment may be set as appropriate so that the component has a color that allows a user to easily handle the component, as an optical member.

The resin contained, as a binder, in the second layer 2 of the present embodiment may contain any additive as long as the additive does not impair the necessary weather resistance and scratch resistance. Examples of the additive include dispersant, curing agent, curing catalyst, plasticizer, thixotropic agent, leveling agent, matting agent, antiseptic agent, ultraviolet light absorber, antioxidant, coupling agent, and organic fine particles.

Preferably, the thickness of the second layer of the present embodiment is in a range equal to or larger than 10 μm and equal to or smaller than 100 μm. If the thickness of the film is smaller than 10 μm, the function for the necessary color and heat blocking performance cannot be achieved sufficiently. In contrast, if the thickness of the film is larger the 100 the film may crack.

### Method of Forming Laminated Film 21

The laminated film 21 of the present embodiment can be formed, for example, by using a method of application. That is, the laminated film 21 can be formed by applying a paint that is a raw material of the first layer 1, onto the surface of the base material 20, and then applying a paint that is a raw material of the second layer 2, onto the surface of the first layer 1, in this order. The paint for each layer can be made by dissolving or dispersing the above-described ingredients for the layer and a curing agent, in solvent.

Examples of the method of application, which is used for making the component, include brush painting, spray painting, dip coating, and transfer. For giving an aesthetic design to the shape of the component, a graining process may be performed on the surface of the coating film.

In addition, for curing the film in making the component, the film may be cured in a room temperature. In another case, the curing may be facilitated by heating the film, or the film may be cured by irradiating the film with ultraviolet light. Examples of the heating apparatus, which is used for heating and curing the film, include a heating furnace, a heater, and an infrared-light source. The temperature at which the curing process is performed is preferably in a range from a room temperature to 400° C., and more preferably, in a range from a room temperature to 200° C.

Apparatus to which Component is Attached

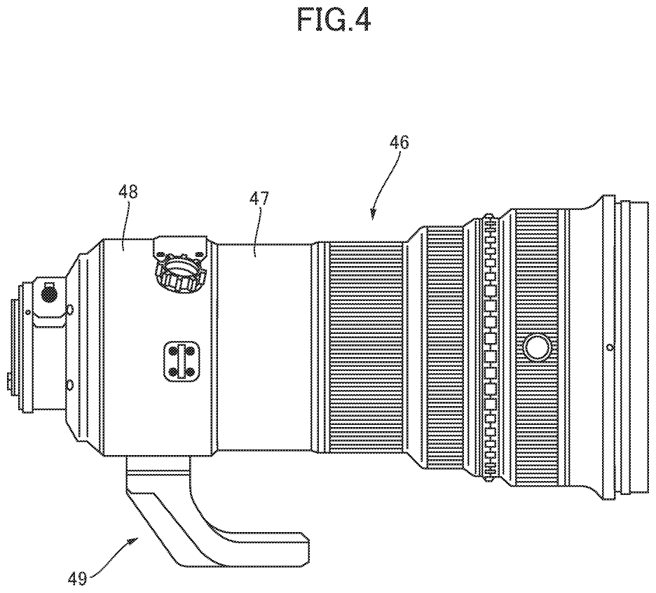

Next, an example of an apparatus that includes the component of the present embodiment will be described. FIG. 4 is an external view of an interchangeable lens for cameras, illustrated as an apparatus of an embodiment of the present invention. The interchangeable lens, which serves as an optical apparatus, includes a lens barrel 46 and a tripod seat 49. The lens barrel 46 includes a lens (not illustrated), a fixed barrel 47, and an annular member 48. Each of the fixed barrel 47 of the lens barrel 46, the annular member 48 of the lens barrel 46, and the tripod seat 49 includes a portion that constitutes the outer surface of the apparatus, and that is exposed to the outside. Of the above-described components, at least the fixed barrel 47 and the annular member 48 have their base materials made of carbon-fiber reinforced plastic, so that the fixed barrel 47 and the annular member 48 have light weight, high strength and high rigidity, and corrosion resistance.

In addition, the laminated film (resin coating film) of the above-described embodiment is formed on each of the fixed barrel 47 and the annular member 48 for reflecting the infrared light, coloring the fixed barrel 47 and the annular member 48 in accordance with the design of the external appearance of the apparatus, and giving the texture to the apparatus. For adjusting the color or glossiness, the paint may contain inorganic particles, such as titanium oxide particles, silicon oxide particles, or other inorganic particles, resin particles, and various organic or inorganic pigments. For increasing the heat blocking performance, the content of the inorganic particles may be increased.

In the embodiment, even when the temperature changes significantly from a low temperature (below the freezing point) to a high temperature, or conversely, from a high temperature to a low temperature, the laminated film (resin coating film) hardly cracks and peels off. Thus, an apparatus having high practicality and durability can be provided.

### EXAMPLES

Next, Examples 1 to 3 in which the present invention is embodied, and Comparative Examples 1 to 3 performed for the comparison with the examples will be described. By using the below-described method, each component in which a laminated film is formed on a base material was made.

### Example 1

### Base Material

First, a sample of carbon-fiber reinforced plastic was prepared. The shape of the sample is a 100 millimeters square, and the thickness of the sample is 2 mm. The sample of the carbon-fiber reinforced plastic is a CFRP (single-layer fiber and thermosetting resin) laminate, a CI-RTP (single-layer fiber and thermoplastic resin) laminate, a CFRP braid, or a CI-RTP braid. The width of the braid was set at 20 mm.

### Paint for First Layer

The paint for Example 1 was made by performing the weighing for obtaining a urethane resin of 120 g, a plasticizer of 8 g, a curing agent of 20 g, and a thinner of 80 g, and by agitating the mixture for ten minutes by using a planetary rotation apparatus (AR-100 made by THINKY CORPORATION). The urethane resin is Polynal 800 (made by OHASHI CHEMICAL INDUSTRIES LTD.). The plasticizer is di-isodecyl phthalate (DIDP made by J-PLUS Co., Ltd.) having a pour point of −50° C. and a boiling point of 476° C. The curing agent is Polynal No. 800 Hardener (made by OHASHI CHEMICAL INDUSTRIES LTD.).

### Paint for Second Layer

The paint for the second layer was made by performing the weighing for obtaining a titanium oxide of 150 g (25 vol % to the volume of the coating film), an acrylic polyol resin of 100 g (55.7 vol % to the volume of the coating film), porous particles of 7 g (2 vol % to the volume of the coating film), a pigment of 1 g (0.5 vol % to the volume of the coating film), a curing agent of 30 g (16.7 vol % to the volume of the coating film), and a thinner of 100 g, and by agitating the mixture for ten minutes by using a planetary rotation apparatus (AR-100 made by THINKY CORPORATION). The titanium oxide is PT-301 (having an average particle diameter of 0.26 μm and made by ISHIHARA SANGYO KAISHA, LTD.). In PT-301, the surface of the titanium oxide particles is coated with silica. The resin is OLESTER Q-691 (made by Mitsui Chemicals, Inc.). The porous particles are 710 (having a pore diameter of 2.5 nm and made by FUJI SILYSIA CHEMICAL LTD.). The pigment is CHROMOFINE BLACK A1103 (made by Dainichiseika Color & Chemicals Mfg. Co., Ltd.). The curing agent is TAKENATE D-120N (made by Mitsui Chemicals, Inc.).

### Method of Forming Laminated Film

By using a spin coater, the paint for the first layer was formed on the base material, and then the paint for the second layer was applied onto the first layer, so that the laminated film was formed. If necessary, a drying process and/or a baking process was performed. The condition for forming the laminated film was adjusted so that the thickness of the first layer is 20 μm and the thickness of the second layer is 35 μm. Note that the thinner contained in the paint volatilizes in the drying process and/or the baking process, and is not left in the layer.

### Example 2

The laminated film of Example 2 was made by using the same method as that for Example 1, except that the amount of the plasticizer contained in the paint for the first layer was set at 25 g.

### Example 3

The laminated film of Example 3 was made by using the same method as that for Example 1, except that the amount of the plasticizer contained in the paint for the first layer was set at 2.0 g.

### Comparative Example 1

The laminated film of Comparative Example 1 was made by using the same method as that for Example 1, except that the amount of the plasticizer contained in the paint for the first layer was set at 40 g.

### Comparative Example 2

The laminated film of Comparative Example 2 was made by using the same method as that for Example 1, except that the amount of the plasticizer contained in the paint for the first layer was set at 1.0 g.

### Comparative Example 3

The laminated film of Comparative Example 3 was made by using the same method as that for Example 1, except that the amount of the plasticizer contained in the paint for the first layer was set at 0.0 g (additive-free).

### Evaluation Method

Next, an evaluation method in which the components of the examples and the comparative examples were evaluated will be described.

### Thermal Shock Test

Each of the components was put in an environmental-temperature testing apparatus, and the thermal shock was applied to the component. Specifically, in one cycle of the thermal shock, the component was left in the environmental-temperature testing apparatus at a temperature of −30° C. for 30 minutes, and then at a temperature of 60° C. for 30 minutes. This cycle was repeated three times. After the thermal shock was applied to the component, whether any cracking or peeling occurred in the laminated film was checked. If neither cracking nor peeling occurred, an evaluation result “A” was given. In contrast, if any cracking or peeling occurred, an evaluation result “B” was given.

### Contact Test

The change in the state of the laminated film was examined by sliding a test tool on the laminated film in a state where the test tool was pressed against the laminated film by a predetermined pressure and was in contact with the laminated film. If no conspicuous change was observed in the state of the laminated film, an evaluation result “A” was given. In contrast, if any change in the state of the laminated film, such as deformation, wear, or peeling, was observed, an evaluation result “B” was given.

### Measurement of Vickers Hardness

### Vickers Hardness of First Layer

After the first layer was formed on the base material, the Vickers hardness of the first layer was measured. Note that the Vickers hardness of the first layer may be measured after the component is completed by forming the second layer. In this case, the second layer may be removed by using an abrasive tool, such as a sandpaper sheet, for exposing the first layer to the outside, and then the Vickers hardness of the first layer may be measured. In the examples and the comparative examples, the measurement was performed on three points of the first layer by using a Micro Vickers Hardness Testing System, HM-102, made by Mitutoyo Corporation, and an average value was calculated. The test force was set at 0.4903 N.

### Vickers Hardness of Second Layer

After the formation of the laminated film, the Vickers hardness of the second layer was measured. The measurement was performed on three points of the second layer by using a Micro Vickers Hardness Testing System, HM-102, made by Mitutoyo Corporation, and an average value was calculated. The test force was set at 0.4903 N.

The evaluation results of Examples 1 to 3 and Comparative Examples 1 to 3 are collectively illustrated in Table 1.

TABLE 1

| | | | | | COMPAR- | COMPAR- | COMPAR- |
|---|---|---|---|---|---|---|---|
| | | EXAMPLE | EXAMPLE | EXAMPLE | ATIVE | ATIVE | ATIVE |
| | | 1 | 2 | 3 | EXAMPLE 1 | EXAMPLE 2 | EXAMPLE 3 |
| PAINT FOR | URETHANE [g] | 120 | 120 | 120 | 120 | 120 | 120 |
| FIRST | PLASTICIZER | 8.0 | 25 | 2.0 | 40 | 1.0 | 0.0 |
| LAYER | (DI-ISODECYL | | | | | | |
| | PHTHALATE) [g] | | | | | | |
| | CURING AGENT [g] | 20 | 20 | 20 | 20 | 20 | 20 |
| | THINNER [g] | 80 | 80 | 80 | 80 | 80 | 80 |
| CONTENT OF PLASTICIZER | | 5.4 | 15.2 | 1.4 | 22.2 | 0.7 | 0.0 |
| CONTAINED IN FIRST LAYER (wt %) | | | | | | | |
| VICKERS | FIRST LAYER | 150 | 60 | 250 | 20 | 300 | 500 |
| HARDNESS | SECOND LAYER | 350 | | | | | |
| [HV] | | | | | | | |

| | | | | | | |
|---|---|---|---|---|---|---|
| RESULT OF THERMAL | A | A | A | A | B | B |
| SHOCK TEST | | | | | | |
| RESULT OF CONTACT TEST | A | A | A | B | A | A |

In addition to the components of Examples 1 to 3 and Comparative Examples 1 to 3, other components in which the content of the plasticizer contained in the first layer was varied were made, and the thermal shock test and the contact test were performed on the components for the examination.

As a result, when the Vickers hardness of the first layer was in a range equal to or smaller than 250 HV, the result of the thermal shock test was acceptable. That is, in this case, although the coefficient of linear expansion of the carbon-fiber reinforced plastic, which serves as a base material, has anisotropy, the laminated film (reflecting film) of the component hardly cracked or peeled off even when the environmental temperature was changed. In contrast, when the Vickers hardness of the first layer was larger than 250 HV, the laminated film tended to easily crack or peel off when applied with the thermal shock. This is because the first layer cannot sufficiently absorb or ease the stress caused by the anisotropy in the thermal expansion of the base material.

When the Vickers hardness was smaller than 50 HV, the result of the contact test was unacceptable in the practicality of the component. This is because the laminated film is too easily deformed when applied with external force.

Thus, if the Vickers hardness of the first layer is in a range equal to or larger than 50 HV and equal to or smaller than 250 HV, the cracking and peeling caused by the thermal shock can be suppressed in the laminated film even if the second layer is made of a material whose Vickers hardness is larger than the Vickers hardness of the first layer (for example, even if the reflecting layer has a Vickers hardness of 350 HV). Note that if the Vickers hardness of the first layer is in a range equal to or larger than 50 HV and equal to or smaller than 250 HV, and the Vickers hardness of the second layer is higher than the Vickers hardness of the first layer, the Vickers hardness of the second layer is necessarily higher than 50 HV Thus, both of the first layer and the second layer can have a certain level of resistance against the external force and the contact, so that the laminated film can have practical strength.

As described above, for forming the film that hardly cracks and peels off even when the temperature changes and that has practical strength against the contact, on the base material made of carbon-fiber reinforced plastic, it is preferable that the Vickers hardness of the first layer be equal to or larger than 50 HV and equal to or smaller than 250 HV, and that the Vickers hardness of the second layer be higher than the Vickers hardness of the first layer. Thus, in the present invention, the coating film that has high resistance, in practical use, against the change in environmental temperature can be formed on the base material made of carbon-fiber reinforced plastic.

### Modifications

The present invention is not limited to the above-described embodiments and examples, and can be variously modified within a technical concept of the present invention. For example, the above-described different embodiments and examples may be combined with each other and embodied.

The component in which the present invention is embodied can be suitably used as an exterior component, a structural component, an operation component, or the like of an optical apparatus that includes optical elements, such as a lens, a prism, a mirror, and an optical filter.

### Other Embodiments

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-84487, filed May 24, 2022 which is hereby incorporated by reference herein in its entirety.

What is claimed is:

1. A component comprising:
a base portion made of fiber-reinforced resin;
a first layer formed on the base portion; and
a second layer formed on the first layer;
wherein a Vickers hardness of the second layer is higher than a Vickers hardness of the first layer, and
wherein the Vickers hardness of the first layer is in a range equal to or larger than 50 HV and equal to or smaller than 250 HV.

2. The component according to claim 1, wherein the base portion includes a plurality of areas in which carbon fibers are arranged in different directions, and
wherein in each of the plurality of areas, a coefficient of linear expansion of the base portion differs, depending on a direction.

3. The component according to claim 2, wherein a maximum value in anisotropy of the coefficient of linear expansion of the base portion is in a range equal to or larger than 100×10⁻⁶/° C. and equal to or smaller than 130×10⁻⁶/° C.

4. The component according to claim 1, wherein the base portion includes a braid layer in which carbon fibers are braided like a braid and which is bonded via resin.

5. The component according to claim 4, wherein the braid layer includes thermoplastic resin.

6. The component according to claim 1, wherein the first layer contains plasticizer whose pour point is equal to or lower than −30° C. and whose boiling point is equal to or higher than 350° C.

7. The component according to claim 6, wherein the first layer contains plasticizer whose pour point is equal to or lower than −40° C. and whose boiling point is equal to or higher than 400° C.

8. The component according to claim 1, wherein the first layer contains plasticizer in a range equal to or larger than 1 wt % and equal to or smaller than 20 wt %.

9. The component according to claim 6, wherein the plasticizer is one or more selected from a group of phthalate diesters, dialkylbenzenes, and sebacate diesters.

10. The component according to claim 1, wherein a thickness of the first layer is in a range equal to or larger than 2 μm and equal to or smaller than 50 μm.

11. The component according to claim 1, wherein the second layer contains inorganic particles and/or resin and/or pigment.

12. The component according to claim 11, wherein the inorganic particles are one or more selected from a group of rutile-type titanium oxide, anatase-type titanium oxide, zirconium oxide, zinc oxide, silica, zirconium oxide, aluminum oxide, and aluminum.

13. The component according to claim 11, wherein the second layer contains the inorganic particles in a range equal to or larger than 20 mass % and equal to or smaller than 70 mass %.

14. The component according to claim 11, wherein the second layer contains titanium-oxide particles, and
wherein an average particle diameter of the titanium-oxide particles is equal to or larger than 10 nm and equal to or smaller than 5.0 μm.

15. The component according to claim 11, wherein the resin is one or more selected from a group of epoxy resin, urethane resin, acrylic resin, acrylic urethane resin, fluororesin, silicone resin, phenol resin, and alkyd resin.

16. The component according to claim 11, wherein an average particle diameter of the pigment is in a range equal to or larger than 10 nm and equal to or smaller than 5000 nm.

17. The component according to claim 11, wherein a content of the pigment contained in the second layer is equal to or smaller than 5 wt %.

18. The component according to claim 1, wherein a thickness of the second layer is in a range equal to or larger than 10 μm and equal to or smaller than 100 μm.

19. An apparatus comprising:
the component according to claim 1; and
a part disposed at a position at which the part is configured to slide on the component.

20. An optical apparatus comprising:
the component according to claim 1; and
an optical element disposed in the component.
